(19) United States
(12) Patent Application Publication
(10) Pub. No.: US 2012/0284180 A1
(43) Pub. Date: Nov. 8, 2012

(54) MOBILE TRANSACTION METHOD AND PORTABLE ELECTRONIC DEVICE FOR MOBILE TRANSACTION

(76) Inventor: Chien-Kang Yang, Taipei City (TW)

(21) Appl. No.: 13/402,838

(22) Filed: Feb. 22, 2012

(30) Foreign Application Priority Data
May 4, 2011 (TW) 100115595

(51) Int. Cl. G06Q 20/34; G06Q 20/40; G06Q 20/08

(52) U.S. Cl. 705/41; 705/39

(57) ABSTRACT

A mobile transaction method is implemented using a portable electronic device for processing a transaction through an electronic transaction platform. The portable electronic device is removably coupled to a payment card that stores payment account information. In the method, the portable electronic device is operable to generate transaction information related to the transaction, to obtain the payment account information from the payment card, to establish a session and communicate with the electronic transaction platform, and to collaborate with the electronic transaction platform to process payment for the transaction.

### CROSS-REFERENCE TO RELATED APPLICATION

This application claims priority of Taiwanese Application No. 100115595, filed on May 4, 2011.

### BACKGROUND OF THE INVENTION

1. Field of the Invention

The invention relates to a mobile transaction method, more particularly to a mobile transaction method to be implemented using a portable electronic device.

2. Description of the Related Art

Point-of-sale (POS) systems are commonly used in retail trade, food industry and hotels, and are capable of handling sales, managing inventory, analyzing customer purchasing behavior, etc.

For a business applying the POS system, customers are allowed to make purchases with a payment card (such as a stored-value card, a debit card, or a credit card) at a sales point of this business that is provided with a card reader capable of reading the payment card. However, the transactions and the payment still have to be processed at specific sales points provided with the card reader, and may be inconvenient for some customers.

### SUMMARY OF THE INVENTION

Therefore, the object of the present invention is to provide a mobile transaction method for processing a transaction without time and space limitations.

Accordingly, a mobile transaction method of the present invention is to be implemented using a portable electronic device for processing a transaction through an electronic transaction platform. The portable electronic device is removably coupled to a payment card that stores payment account information. The method comprises the following steps of:

A) configuring the portable electronic device to generate transaction information related to the transaction;

B) configuring the portable electronic device to obtain the payment account information from the payment card;

C) configuring the portable electronic device to establish a session with the electronic transaction platform, and to communicate with the electronic transaction platform according to the session; and

D) configuring the portable electronic device to collaborate with the electronic transaction platform to process payment for the transaction according to the transaction information generated in step A) and the payment account information obtained in step B).

Another object of the present invention is to provide a portable electronic device operable to implement the mobile transaction method.

Accordingly, a portable electronic device of the present invention is operable to cooperatively communicate with an electronic transaction platform for processing a transaction through the electronic transaction platform. The portable electronic device comprises a memory card interface and a processor. The memory card interface is operable to be removably coupled to a payment card that includes a smart chip storing payment account information and a controller for accessing the smart chip. The processor is coupled to the memory card interface, and is operable to:

generate transaction information according to the transaction,

cooperate with the controller of the payment card so as to obtain the payment account information from the smart chip through the memory card interface,

establish a session with the electronic transaction platform and communicate with the electronic transaction platform according to the session,

cooperate with the electronic transaction platform to process payment for the transaction according to the transaction information and the payment account information, and

terminate the session with the electronic transaction platform when the payment is completed.

### BRIEF DESCRIPTION OF THE DRAWINGS

Other features and advantages of the present invention will become apparent in the following detailed description of the preferred embodiment with reference to the accompanying drawings, of which:

FIG. 1 is a block diagram of a preferred embodiment of a portable electronic device for mobile transaction according to this invention;

FIG. 2 is a block diagram illustrating a relationship among the portable electronic device, an electronic transaction platform, a banking system, and an electronic device associated with a seller;

FIG. 3 is a flow chart of a preferred embodiment of a mobile transaction method according to the present invention;

FIG. 4 is a flow chart illustrating sub-steps for obtaining payment account information from a payment card; and

FIG. 5 is a flow chart illustrating sub-steps for generating a message authentication code.

### DETAILED DESCRIPTION OF THE PREFERRED EMBODIMENT

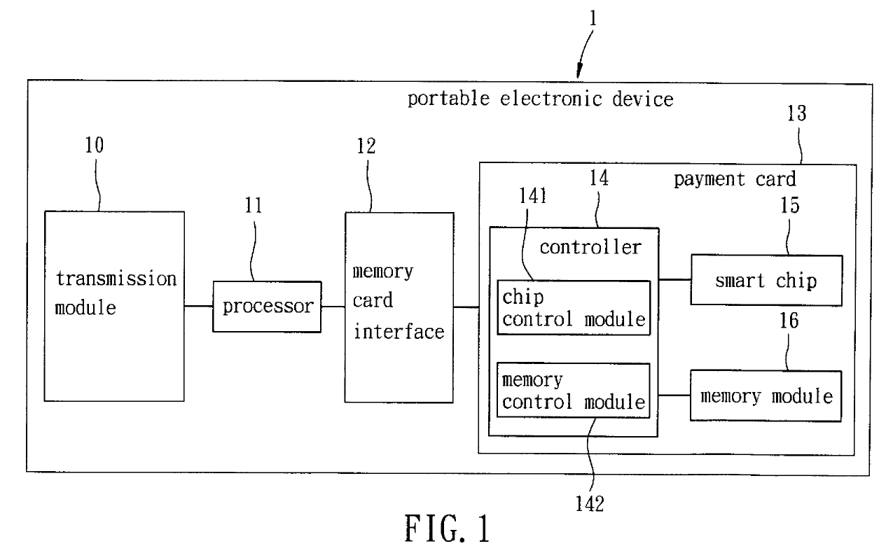

As shown in FIG. 1, the preferred embodiment of a portable electronic device 1 according to the present invention includes a transmission module 10, a processor 11 coupled to the transmission module 10, and a memory card interface 12 coupled to the processor 11 and removably coupled to a payment card 13. In this embodiment, the portable electronic device 1 can be a mobile phone capable of communicating with other devices through the transmission module 10. The memory card interface 12 can be an interface compatible with various existing memory cards, such as a secure digital (SD) card, a microSD card, a miniSD card, a compact flash (CF) card, etc.

The payment card 13 includes a controller 14, a smart chip 15 coupled to the controller 14, and a memory module 16 coupled to the controller 14. The controller 14 includes a chip control module 141 for accessing the smart chip 15, and a memory control module 142 for accessing the memory module 16. It is worth noting that the payment card 13 is removably coupled to the portable electronic device 1 through the memory card interface 12 which is built in the portable electronic device 1, and thus there is no additional hardware cost for the portable electronic device 1.

In this embodiment, the smart chip 15 of the payment card 13 and transmission protocols between the controller 14 and the smart chip 15 conform with an international standard ISO/IEC 7816, which is managed jointly by the International Organization for Standardization (ISO) and the International Electrotechnical Commission (IEC). Specifically, the smart chip 15 is standardized and issued by Finance Information Service Co., LTD. The memory module 16 is a non-volatile memory, such as a flash memory.

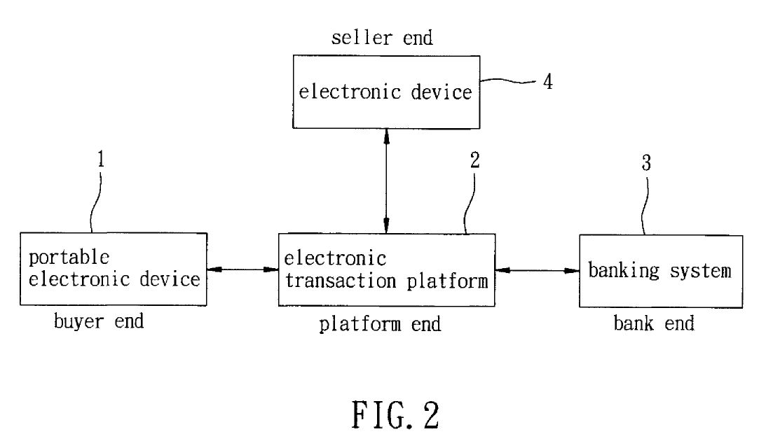

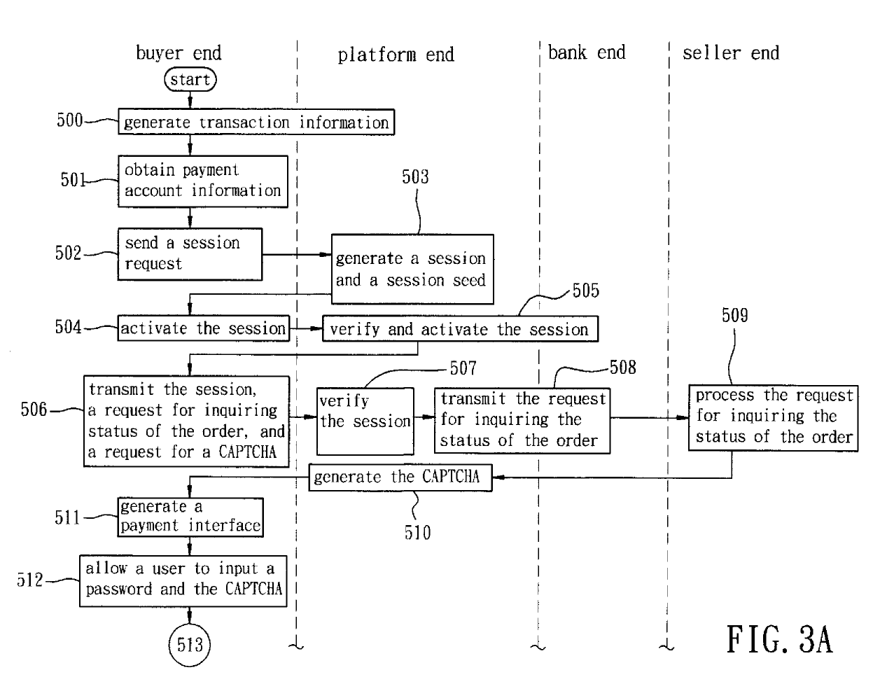

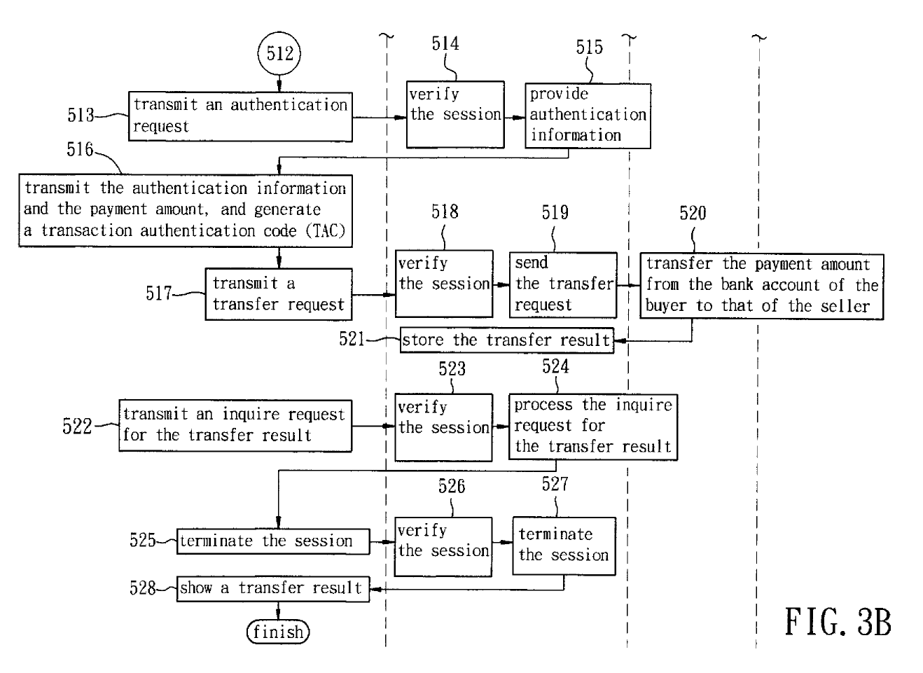

Further referring to FIGS. 2 and 3, a mobile transaction method is to be implemented using the portable electronic device 1 for processing a transaction with a seller through an electronic transaction platform 2 and a banking system 3 associated with a bank. The portable electronic device 1, the banking system 3, and an electronic device 4 associated with the seller are configured to communicate separately with the electronic transaction platform 2. In this embodiment, the payment card 13 is cooperatively issued by the electronic transaction platform 2 and the bank, and is specific to the bank such that payments from the payment card 13 can be accepted by the bank. The seller is recognized by the electronic transaction platform 2 to provide merchandise or services therethrough, and a user of the portable electronic device 1 is a potential buyer.

Before the mobile transaction can take place, an application program (AP) that is related to the payment card 13, and an application program interface (APT) that was developed based on the AP are required to be installed in the operating system (OS) of the portable electronic device 1 in advance. The AP is operable to provide the following functions:

identifying the payment card 13 that is coupled to the memory card interface 12 of the portable electronic device 1;

initializing parameters of the payment card 13;

releasing memory space used for initialization of the payment card 13;

establishing/terminating a communication link between the processor 11 of the portable electronic device 1 and the smart chip 15 of the payment card 13;

starting/terminating a transaction function with the smart chip 15 of the payment card 13, where a new transaction function can be started only after all other transaction functions are terminated;

after starting the transaction function, executing the commands associated with the started transaction function, such as obtaining information from the payment card 13, processing message authentication code (MAC), generating transaction authentication code (TAC), encrypting/decrypting message, etc.;

resetting the controller 14 of the payment card 13;

obtaining an identification number of the memory module 16, e.g., Flash ID; and

obtaining the version information of the API package.

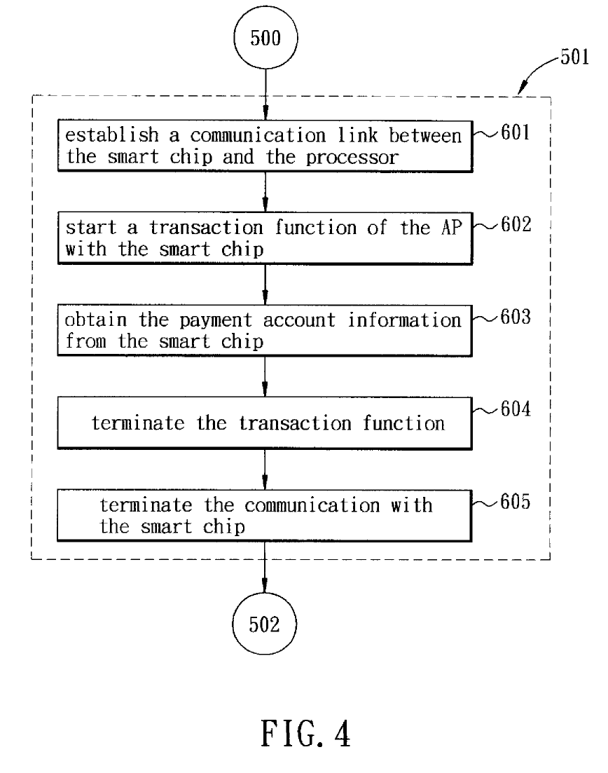

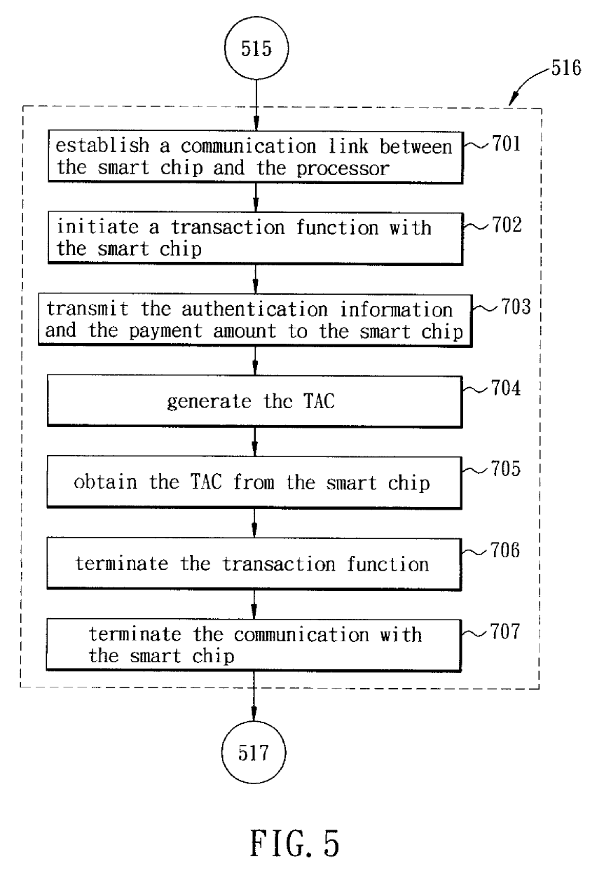

In this embodiment, the portable electronic device 1, which has been installed with the AP and the API, is operable to display an icon that links to the electronic transaction platform 2 on a display (not shown in the Figures) of the portable electronic device 1. When the icon is clicked, the user of the portable electronic device 1 may select a desired merchandise or service provided by various sellers through the electronic transaction platform 2. After the selection is finished, a transaction signal, which is generated by an input device (not shown) of the portable electronic device 1 in response to operation of the user for the selection, is transmitted to the processor 11 of the portable electronic device 1, and the portable electronic device 1 is operable to execute the mobile transaction method of this invention to complete the transaction. The mobile transaction method will now be described with further reference to FIGS. 3 to 5.

In step 500, the processor 11 of the portable electronic device 1 is operable to receive the transaction signal, and to generate transaction information related to the transaction according to the transaction signal. In this embodiment, the transaction information includes a serial number of an order for the transaction, date and time of the transaction, and a payment amount of the order for the transaction.

In step 501, the processor 11 of the portable electronic device 1 is operable to obtain payment account information from the payment card 13. In this embodiment, the payment account information is stored in the smart chip 15 of the payment card 13, and includes an identification number associated with the payment card 13, a bank account number at the bank issuing the payment card 13, and a bank code associated with the bank. In particular, step 501 includes the following sub-steps 601 to 605.

In sub-step 601, the processor 11 of the portable electronic device 1 is operable to communicate with the smart chip 15 of the payment card 13. In particular, the processor 11 is operable to establish a communication link between the smart chip 15 of the payment card 13 and the AP executed by the processor 11.

In sub-step 602, the processor 11 of the portable electronic device 1 is operable to start a transaction function of the AP with the smart chip 15 of the payment card 13.

In sub-step 603, the processor 11 of the portable electronic device 1 is operable to cooperate with the controller 14 of the payment card 13 so as to obtain the payment account information from the smart chip 15 through the memory card interface 12.

The processor 11 of the portable electronic device 1 is operable to terminate the transaction function in sub-step 604, and to terminate the communication with the smart chip 15 of the payment card 13 in sub-step 605. After obtaining the payment account information, the flow goes to step 502.

In step 502, the processor 11 of the portable electronic device 1 is operable to send a session request to the electronic transaction platform 2 via the transmission module 10, in order to establish a session with the electronic transaction platform 2. The session is used for securing data transmission, including the transaction information and the payment account information, between the portable electronic device 1 and the electronic transaction platform 2 during the mobile transaction. Since control and management of the session are readily appreciated by those skilled in the art, and details thereof are omitted herein for the sake of brevity.

In step 503, the electronic transaction platform 2 is operable to generate a session and a session seed that is encrypted and authenticated, and to transmit the session and the session seed to the portable electronic device 1 in response to the session request from the portable electronic device 1. The session means parameters, variables and data used in the session.

In step 504, the processor 11 of the portable electronic device 1 is operable to activate the session with the electronic transaction platform 2 by transmitting the session back to the electronic transaction platform 2 through the transmission module 10.

In step 505, the electronic transaction platform 2 is operable to verify and activate the session with the portable electronic device 1, and to accordingly transmit a successful result of activation of the session to the portable electronic device 1 when the session is successfully established therebetween.

In step 506, after receiving the successful result of the activation of the session, the processor 11 of the portable electronic device 1 is operable to transmit through the transmission module 10 the session along with a request for inquiring status of the order of the transaction and a request for asking an Completely Automated Public Turing test to tell Computers and Humans Apart (CAPTCHA) to the electronic transaction platform 2. In this embodiment, the request for inquiring the status of the order includes the transaction information, and the CAPTCHA is used for ensuring that the transaction signal is generated by a real person. Additionally, the processor 11 of the portable electronic device 1 is operable to communicate with the electronic transaction platform 2 according to the session thus established before the payment for the order of the transaction is completed.

The electronic transaction platform 2 is operable to verify the session in step 507, and to transmit the request for inquiring the status of the order to the electronic device 4 associated with the seller providing the order to the user in step 508.

In step 509, the electronic device 4 is operable to process the request for inquiring the status of the order, and to accordingly transmit a status of the order to the electronic transaction platform 2.

In step 510, the electronic transaction platform 2 is operable to generate the CAPTCHA, and transmits the CAPTCHA along with the status of the order to the portable electronic device 1.

In step 511, the processor 11 of the portable electronic device 1 is operable to generate an image to ask the user to make payment for the order of the transaction, and to show the user the image and the CAPTCHA on the display of the portable electronic device 1.

In step 512, the processor 11 of the portable electronic device 1 is operable to allow the user to input the CAPTCHA and a password associated with the payment card 13.

When it is verified that the password is authentic and the CAPTCHA is correct, the processor 11 of the portable electronic device 1 is operable, in step 513, to transmit an authentication request along with the session to the electronic transaction plat form 2 through the transmission module 10. In this embodiment, the portable electronic device 1 and the electronic transaction platform 2 are configured to identify the transaction with each other according to the authentication information.

In response to receipt of the authentication request from the portable electronic device 1, the electronic transaction platform 2 is operable to verify the session in step 514, and to provide authentication information to the portable electronic device 1 in step 515 when the verification in step 514 is successful. The authentication information includes a terminal serial number, a terminal check number, a date and time of the authentication, a bank account number associated with the seller for receiving the payment, a bank code of a bank of the bank account number for receiving the payment, a transaction serial number corresponding to the transaction, and a payment request identification number that is generated by the electronic transaction platform 2 in response to the authentication request. The payment request identification number is associated with the portable electronic device 1, and is for the portable electronic device 1 and the electronic transaction platform 2 to confirm details of the payment with each other.

In step 516, the processor 11 of the portable electronic device 1 is operable to communicate with the smart chip 15 of the payment card 13, and to start a transaction function of the AP. In this transaction function, the authentication information and the payment amount are transmitted to the smart chip 15 through the memory card interface 12 and the chip control module 141, the smart chip 15 is operable to generate a TAC accordingly, and the processor 11 is operable to cooperate with the chip control module 141 so as to obtain the message authentication code through the memory card interface 12.

Specifically, step 516 includes the following sub-steps 701 to 707.

In sub-step 701, the processor 11 of the portable electronic device 1 is operable to establish a communication link between the smart chip 15 of the payment card 13 and the AP executed by the processor 11.

In sub-step 702, the processor 11 of the portable electronic device 1 is operable to initiate the transaction function with the smart chip 15 of the payment card 13 via the AP of the processor 11.

In sub-step 703, the processor 11 of the portable electronic device 1 is operable to cooperate with the chip control module 141 to transmit the authentication information and the payment amount to the smart chip 15 through the memory card interface 12.

In sub-step 704, the smart chip 15 is operable to generate the TAC. Since the techniques related to the message authentication code are well known to those skilled in art, details thereof are omitted herein for the sake of brevity.

In sub-step 705, the processor 11 of the portable electronic device 1 is operable to cooperate with the chip control module 141 so as to obtain the TAC from the smart chip 15 through the memory card interface 12.

Then, the processor 11 of the portable electronic device 1 is operable to terminate the transaction function in sub-step 706, and to terminate the communication with the smart chip 15 of the payment card 13 in sub-step 707. The flow subsequently goes to step 517.

In step 517, the processor 11 of the portable electronic device 1 is operable to transmit a transfer request along with a session to the electronic transaction platform 2 through the transmission module 10. In this embodiment, the transfer request includes the transaction information, the payment account information, the CAPTCHA, the bank account number for receiving the payment, the bank code of the bank of the bank account number for receiving the payment, the payment request identification number, and the message authentication code.

In step 518, the electronic transaction platform 2 is operable to verify the session received in step 517. In step 519, the electronic transaction platform 2 is operable to send the transfer request to the banking system 3 so as to notify the banking system 3 to process the payment for the order of the transaction.

In step 520, the banking system 3 is operable to process the payment according to the transfer request (i.e., to transfer the payment amount from the bank account of the buyer to that of the seller), and to generate a transfer result that is to be transmitted to the electric transaction platform 2 thereafter. The transfer result includes a payment serial number, a receipt number and a receipt status related to the payment thus processed.

In step 521, the electronic transaction platform 2 is operable to receive and store the transfer result.

In step 522, the processor 11 of the portable electronic device 1 is operable to transmit an inquire request for the transfer result, along with a session to the electronic transaction platform 2 through the transmission module 10.

In step 523, the electronic transaction platform 2 is operable to verify the session received in step 522. In step 524, the electronic transaction platform 2 is operable to process the inquire request, and to transmit the transfer result to the processor 11 of the portable electronic device 1. In this embodiment, the processor 11 of the portable electronic device 1 is operable to determine whether a predetermined waiting time has elapsed, i.e., to determine whether the electronic transaction platform 2 has timed-out. When the processer 11 receives the transfer result within the predetermined waiting time, the flow goes to step 525. Otherwise, the processor 11 of the portable electronic device 1 is operable to show a message notifying that the payment for the order has not yet been completed on the display of the portable electronic device 1.

The payment process for the order of the transaction is considered to have been successfully completed when the portable electronic device 1 receives the transfer result. Then, the portable electronic device 1 is operable to terminate the session with the electronic transaction platform 2, and to transmit a session for terminating the session to the electronic transaction platform 2 via the transmission module 10.

In step 526, the electronic transaction platform 2 is operable to verify the session received in step 525. In step 527, the electronic transaction platform 2 is operable to terminate the session with the portable electronic device 1.

In step 528, the processor 11 of the portable electronic device 1 is operable to show the transfer result on the display of the portable electronic device 1.

To sum up, the portable electronic device 1 is operable to cooperate with the payment card 13, and to implement the mobile transaction method without time and space limitations so as to facilitate the purchasing behavior of the user. In other words, the chip control module 141 of the controller 14 can be considered as a card reader for the smart chip 15, and is configured to handle functions of a terminal device (e.g., a credit card reader) that is for payment processing in a point-of-sale system, such that the portable electronic device 1 installed with the AP and API associated with the payment card 13 can be considered as a point-of-sale system. Additionally, the data transmission between the portable electronic device 1 and the electronic transaction platform 2 is secured by the session and session seed that is encrypted during the transaction.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A mobile transaction method to be implemented using a portable electronic device for processing a transaction through an electronic transaction platform, the portable electronic device being removably coupled to a payment card that stores payment account information, the method comprising the following steps of:
A) configuring the portable electronic device to generate transaction information related to the transaction;
B) configuring the portable electronic device to obtain the payment account information from the payment card;
C) configuring the portable electronic device to establish a session with the electronic transaction platform, and to communicate with the electronic transaction platform according to the session; and
D) configuring the portable electronic device to collaborate with the electronic transaction platform to process payment for the transaction according to the transaction information generated in step A) and the payment account information obtained in step B).

2. The mobile transaction method as claimed in claim 1, wherein the payment account information obtained in step B) includes an identification number associated with the payment card, a bank account number to which the payment processed in step D) is charged, and a bank code associated with a bank issuing the bank account number.

3. The mobile transaction method as claimed in claim 2, wherein the payment card is cooperatively issued by the electronic transaction platform and the bank, and is specific to the bank.

4. The mobile transaction method as claimed in claim 1, the portable electronic device including a processor and a memory card interface that is coupled to the processor and the payment card, the payment card including a smart chip and a controller for the smart chip, wherein step B) includes the following sub-steps of:
B1) configuring the processor of the portable electronic device to communicate with the smart chip of the payment card;
B2) configuring the processor of the portable electronic device to start a transaction function with the smart chip of the payment card;
B3) configuring the processor of the portable electronic device to cooperate with the controller of the payment card so as to obtain the payment account information from the smart chip through the memory card interface;
B4) configuring the processor of the portable electronic device to terminate the transaction function; and
B5) configuring the processor of the portable electronic device to terminate the communication with the smart chip of the payment card.

5. The mobile transaction method as claimed in claim 1, further comprising, after step D), the step of:
configuring the portable electronic device to terminate the session with the electronic transaction platform when the payment is completed.

6. The mobile transaction method as claimed in claim 4, wherein the transaction information includes a payment amount for the transaction.

7. The mobile transaction method as claimed in claim 1, the portable electronic device including a processor and a memory card interface that is coupled to the processor and that is operable to connect to the payment card, the payment card including a smart chip and a controller for the smart chip, wherein step D) includes the following sub-steps of:
D1) configuring the processor of the portable electronic device to transmit an authentication request to the electronic transaction platform, so that the electronic transaction platform is operable to provide authentication information to the portable electronic device in response to receipt of the authentication request from the portable electronic device, the portable electronic device and the electronic transaction platform being configured to identify the transaction with each other according to the authentication information;
D2) configuring the processor of the portable electronic device to cooperate with the controller of the payment card to transmit the authentication information and the payment amount to the smart chip through the memory card interface and for generating a transaction authentication code by the controller; and
D3) configuring the processor of the portable electronic device to obtain the transaction authentication code from the smart chip through the memory card interface.

8. The mobile transaction method as claimed in claim 7, wherein step D) further includes the following sub-steps of:
before sub-step D2), configuring the processor of the portable electronic device to communicate with the smart chip of the payment card, and to initiate a transaction function with the smart chip of the payment card; and
after sub-step D3), configuring the processor of the portable electronic device to terminate the transaction function the communication with the smart chip of the payment card, and to terminate the communication with the smart chip of the payment card.

9. The mobile transaction method as claimed in claim 7, wherein, in sub-step D2), the authentication information includes a terminal serial number, a terminal check number, a date and time of the authentication, a bank account number for receiving the payment, a bank code associated with a bank of the bank account number for receiving the payment, and a transaction serial number.

10. The mobile transaction method as claimed in claim 7, wherein the payment card is issued by a bank associated with a banking system, and step D), after sub-step D3) further includes the sub-step of:
configuring the processor of the portable electronic device to transmit a transfer request to the electronic transaction platform so that the electronic transaction platform is operable, in response to receipt of the transfer request, to notify the banking system of the bank to process the payment according to the transfer request, the transfer request including the transaction information, the payment account information, and the message authentication code.

11. The mobile transaction method as claimed in claim 10, wherein step D), after the sub-step of transmitting the transfer request, further includes the sub-steps of:
configuring the processor of the portable electronic device to transmit an inquire request to the electronic transaction platform, so that the electronic transaction platform is operable, in response to receipt to the inquire request, to transmit to the processor of the portable electronic device a transfer result that is generated by the banking system after the payment is processed, that is received by the electronic transaction platform from the banking system, and that includes a payment serial number, a receipt number and a receipt status related to the payment thus processed.

12. A portable electronic device configured to cooperatively communicate with an electronic transaction platform for processing a transaction through the electronic transaction platform, said portable electronic device comprising:
a memory card interface configured to be removably coupled to a payment card that includes a smart chip storing payment account information and a controller for accessing said smart chip; and
a processor coupled to said memory card interface and configured to
generate transaction information according to the transaction,
cooperate with the controller of the payment card so as to obtain the payment account information from the smart chip through the memory card interface,
establish a session with the electronic transaction platform and communicate with the electronic transaction platform according to the session,
cooperate with the electronic transaction platform to process payment for the transaction according to the transaction information and the payment account information, and
terminate the session with the electronic transaction platform when the payment is completed.

13. The portable electronic device as claimed in claim 12, wherein the smart chip of the payment card and transmission protocols between the controller and the smart chip conform with an international standard managed jointly by the International Organization for Standardization (ISO) and the International Electrotechnical Commission (TEC).

14. The portable electronic device as claimed in claim 13, wherein the international standard is ISO/IEC 7816.

15. The portable electronic device as claimed in claim 12, wherein the smart card is cooperatively issued by the electronic transaction platform and a bank, and is specific to the bank.
